(19) United States
(12) Patent Application Publication
(10) Pub. No.: US 2026/0219433 A1
(43) Pub. Date: Jul. 30, 2026

(54) HOUSING ASSEMBLY AND ELECTRONIC DEVICE

(71) Applicant: Murrelektronik GmbH, Oppenweiler (DE)

(72) Inventors: Tim ROOLF, Oppenweiler (DE); Heiko FEISST, Oppenweiler (DE); Heike JACOB, Oppenweiler (DE); Angelo ALGERI, Oppenweiler (DE)

(21) Appl. No.: 19/460,823

(22) Filed: Jan. 27, 2026

(30) Foreign Application Priority Data
Jan. 28, 2025 (DE) 10 2025 102 949.0

(51) Int. Cl. F21V 8/00

(52) U.S. Cl. CPC G02B 6/0016

(57) ABSTRACT

A housing assembly for an electronic device including a partially transparent housing part formed in one piece, having a connection side wall, first and second longitudinal side walls, and first and second end side walls. The side walls delimit a receiving space for an electronic component. A section of the housing part is designed as a light guide with a coupling-in surface for coupling in light from the receiving space, a first coupling-out surface arranged on the connection side wall such that at least part of the light coupled in is coupled out perpendicular to the connection side wall, and a second coupling-out surface arranged on one of the longitudinal or end side walls such that at least part of the light coupled in is coupled out perpendicular to the respective longitudinal or end side wall. An electronic device having a corresponding housing assembly.

### FIELD OF THE DISCLOSURE

Embodiments of the present disclosure relate to a housing assembly and to an electronic device.

### BACKGROUND

In electronic devices known from the prior art, light-emitting diodes are often used to signal operating states. It is for example possible to display states such as power supply (“power on”), errors, status information, or specific functions.

Openings are often incorporated in the housing to implement the indicator lights. The openings are either assigned to the light-emitting diodes themselves or to light guides which cooperate with the light-emitting diodes and transport the light they emit. However, the openings reduce the protective effect of the housing, so that the device electronics are less well protected against external influences such as moisture or dust.

In addition, light escaping from the housing through an opening is often only visible when viewing the device from the side on which the respective opening is located. Visibility is therefore limited.

If the light is to be seen from different sides, additional openings must be incorporated on the respective sides of the housing. Continuous optical signaling across a corner of the housing is also possible in principle. To this end, an additional opening must be provided directly in the corner of the housing. However, such an opening may have an adverse effect on the stability of the housing.

### SUMMARY

The object is therefore to provide an electronic device having a indicator light which is technically easy to implement and clearly visible.

The object is achieved by a housing assembly for an electronic device, comprising at least one partially transparent housing part which is formed in one piece, having a connection side wall, a first longitudinal side wall, a second longitudinal side wall, a first end side wall, and a second end side wall. The side walls together delimit a receiving space for at least one electronic component of the electronic device. At least a section of the housing part is designed as a light guide which has a coupling-in surface for coupling in light from the receiving space, a first coupling-out surface for coupling out light, which is arranged on the connection side wall such that at least part of the light coupled in is coupled out perpendicular to the connection side wall, and which has a second coupling-out surface for coupling out light, which is arranged on one of the longitudinal side walls or end side walls such that at least part of the light coupled in is coupled out perpendicular to the respective longitudinal side wall or end side wall.

The basic idea is to use the one-piece housing part itself as a light guide and thus to couple light out of the housing on at least two different sides, namely the connection side wall and one of the longitudinal side walls or end side walls. This effectively protects the electronics inside the housing, as no openings are required in the outer shell for the coupling-out of light, while at the same time creating a indicator light which is clearly visible from different viewing directions.

For example, the first coupling-out surface is arranged parallel to the connection side wall. The second coupling-out surface is preferably arranged parallel to the longitudinal side wall or end side wall on which it is located.

The geometric complexity of the housing assembly is kept low by the arrangement of the first and the second coupling-out surface, in particular parallel to the respective walls of the housing part. No bevels or other external contour adjustments need to be provided on the housing part to achieve the aforementioned good visibility from different viewing directions.

Of course, the housing part may also have several sections, each of which is designed as an independent light guide. Each of the sections may be assigned to different light sources, allowing different information to be displayed.

The one-piece housing part may be referred to as pot- or cup-shaped, as it only has one open side. The shape of the housing part can be cuboid, wherein the edges of the cuboid can be machined, e.g., rounded or flattened.

In one variant embodiment, the housing assembly comprises an extension provided on one of the longitudinal side walls or end side walls, which protrudes into the receiving space and comprises the coupling-in surface. The extension preferably forms at least part of the light guide. For example, the extension is designed as a rib which extends along the relevant longitudinal side wall or end side wall in the direction of the connecting side wall. This geometry is technically easy to manufacture, for example in an injection molding process.

The housing part may be manufactured in an injection molding process in which the extension protruding into the receiving space is simultaneously produced together with the corresponding longitudinal side wall or end side wall. The extension also allows the coupling-in surface to be positioned very close to the light source. A particularly large proportion of the light emitted by the light source can thus be coupled into the light guide and transported to the coupling-out surfaces.

It may also be provided that the first coupling-out surface and the second coupling-out surface merge into each other and form a common coupling-out surface which extends continuously on an outer side of the housing part from the respective longitudinal side wall or end side wall to the connecting side wall. For example, the transition between the first and the second coupling-out surface may be formed by a curvature or an edge. In principle, the respective coupling-out surfaces may each be designed so as to be planar and merge into each other in the transition area. Alternatively, the respective coupling-out surfaces may themselves be curved such that they merge into each other, preferably without edges where they meet.

For example, the common coupling-out surface extends over an angular range of at least 45°, preferably 90°, around the housing, in particular around the corner between the connection side wall and the longitudinal or end side wall. This results in a particularly good perceptibility of the emitted light from different directions. In particular, the common coupling-out surface can be viewed over a continuous angular range of at least 135°, preferably up to 270°, around the housing.

In a further variant, the housing part comprises an engagement geometry into which a shielding element can engage so as to shield and/or reflect light coupling out of the light guide into the receiving space during operation. This reliably prevents unwanted coupling-out of light into the housing. It is thus ensured that the light coupled into the light guide is conducted at least approximately completely to the respective coupling-out surfaces and is coupled out there.

In a further embodiment, the connection side wall, the first longitudinal side wall, the second longitudinal side wall, the first end side wall, and the second end side wall are formed from an at least partially transparent material comprising homogeneously distributed optical scatterers. The light coupled into the housing part, in particular into the light guide, is scattered by the optical scatterers and thus distributed and/or homogenized.

Preferably, the optical scatterers are also arranged between the coupling-in surface and the first coupling-out surface and are designed to scatter the light coupled in via the coupling-in surface such that a scattered portion of the light strikes the second coupling-out surface. In simple terms, this allows a portion of the light coupled into the light guide to be deflected so that it reaches the second coupling-out surface and is coupled out there.

In a further variant of the housing assembly, at least part of the second coupling-out surface is formed by a side face of the light guide, and a concentration of the optical scatterers in the at least partially transparent material is so high that at least 15%, 25%, preferably 50% or even more than 75% of the light coupled into the light guide during operation is scattered in the light guide by the optical scatterers such that it is coupled out through the side face of the light guide. The optical scatterers can therefore deflect at least half of the light coupled into the light guide such that it exits the housing part from the side face of the light guide. In this case, the side face of the light guide from which the scattered light emerges forms the second coupling-out surface. Particularly good visibility is achieved due to the high proportion of light emerging there.

In particular, it may also be provided that the concentration of the optical scatterers in the at least partially transparent material is so high that, due to the scattering of the light coupled in, so much light is coupled out of the light guide at the side that at least approximately equal luminance values are achieved for the first and the second coupling-out surface.

Approximately equal luminance values means that a first luminance value of light coupled out from the first coupling-out surface and a second luminance value of light coupled out from the second coupling-out surface deviate by no more than 20%, preferably no more than 10%, from a common mean value. Equally good visibility of the light coupled out on the different sides of the housing is thus achieved.

In a further variant embodiment, the optical scatterers are color pigments which are designed to scatter light coupled into the light guide during operation and at the same time color the housing part in a predetermined color. The coloring can be achieved by the color pigments absorbing light of a certain wavelength. Preferably, this wavelength is different from the wavelength of the light emitted by the light source in the housing. In 15 other words, the color pigments may thus have an absorption spectrum which absorbs light in a specific wavelength range which differs from the wavelength range in which the light source emits light during operation. For example, if the color pigments efficiently absorb blue light with a wavelength of approximately 450 nm and red light with a wavelength of approximately 650 nm, but absorb comparatively little green light with a wavelength of approximately 550 nm and/or reflect it instead, the housing assembly appears green when illuminated with white light. At the same time, green light emitted by the light source and coupled into the light guide is scattered by the color pigments and can thus reach the coupling-out surfaces with comparatively low parasitic absorption by the light guide.

The object is further achieved by an electronic device comprising a housing assembly according to the present disclosure, a printed circuit board received in the receiving space of the housing assembly and having at least one light source, which is arranged such that light emitted by the light source during operation is coupled through the coupling-in surface into the section of the housing part designed as a light guide, and a housing base which closes the receiving space.

The advantages already discussed above in relation to the housing assembly apply equally to the electronic device. The housing base closes and seals the receiving space. The printed circuit board may be coupled to the housing base so that when the receiving space is closed with the housing base, the printed circuit board is inserted into the receiving space.

In one variant of the electronic device, at least a section of the housing base is designed as a shielding element which protrudes into the receiving space and engages with an engagement geometry of the housing part so as to shield and/or reflect light coupling out of the light guide into the receiving space during operation. The shielding element ensures that the light coupled into the light guide does not unintentionally couple out into the receiving chamber and is thus lost.

For example, both the shielding element and the engagement geometry are designed as ribs which engage with each other. Rib-shaped engagement geometries or shielding elements are technically particularly easy to manufacture, for example by injection molding, and enable particularly efficient limitation of light propagation.

In addition, the shielding element can be used to optically separate several light guides formed by the housing part from each other, so that light transmission from one of the light guides to another of the light guides is prevented or at least reduced. In this way, different, in particular differently colored, indicator lights can be realized in the same transparent housing component.

### BRIEF DESCRIPTION OF THE DRAWINGS

Further features and advantages of the present disclosure will become apparent from the description below and the drawings to which reference is made and in which:

FIG. 1 shows a schematic three-dimensional representation of an electronic device in accordance with an exemplary embodiment of the present disclosure with a housing assembly according to an exemplary embodiment of the present disclosure;

FIG. 2 shows a schematic three-dimensional representation of a portion of the electronic device from FIG. 1 with a light guide; and

FIG. 3 shows a schematic representation of a section of the light guide from FIG. 2 in a sectional view.

### DETAILED DESCRIPTION

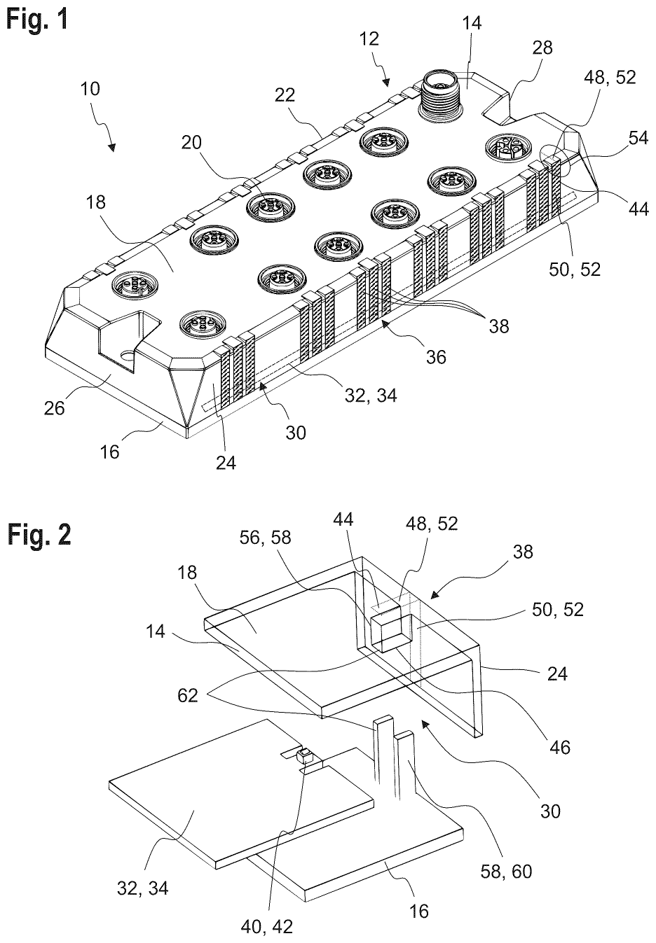

FIG. 1 shows an electronic device 10 according to an exemplary embodiment of the present disclosure, which is designed as a fieldbus module for an industrial plant.

The electronic device 10 comprises a housing assembly 12 having a one-piece housing part 14 and a one-piece housing base 16.

The housing part 14 is made of an at least partially transparent material, for example a thermoplastic material. This allows light that strikes the housing part 14 to be coupled therein and coupled out again at another point.

The housing part 14 has a connection side wall 18 including a plurality of connections 20, a first longitudinal side wall 22, a second longitudinal side wall 24, a first end side wall 26, and a second end side wall 28, which together form a receiving space 30. The first longitudinal side wall 22 is opposite the second longitudinal side wall 24. The first end side wall 26 is opposite the second end side wall 28.

Furthermore, the electronic device 10 shown in FIG. 1 has an electronic component 32, for example a printed circuit board 34, which is completely received in the receiving space 30.

The housing base 16 is connected to the housing part 14 so as to close, in particular sealingly close the receiving space 30 and protects the electronic component 32 in the receiving space 30 from external influences.

The electronic device 10 shown in FIG. 1 has a plurality of indicator lights 36 which are assigned to the respective connections 20.

Each of the indicator lights 36 comprises three display elements 38 which can emit light in different colors. For example, one of the display elements 38 can emit green light, another yellow light, and yet another red light.

The color of the light allows the indicator lights 36 to display different states of the respective connections 20, for example, whether a connection 20 is functioning properly, is occupied, and/or whether there is a malfunction.

In principle, the individual display elements 38 can light up continuously or alternately or flash to be able to display several states per display element 38.

FIG. 2 schematically shows a three-dimensional representation of a portion of the electronic device 10 from FIG. 1 in an exploded view. For the sake of simplicity of the representation, only one of the display elements 38 is shown.

The display element 38 shown is formed by a light source 40, for example a light-emitting diode 42, and a transparent section of the housing part 14, which acts as a light guide 44.

The light source 40 is arranged on the printed circuit board 34 within the receiving space 30 of the housing part 14.

Of course, the arrangement shown in FIG. 2 is not to be understood in a restrictive manner. In particular, a plurality of different light sources 40 may also be arranged next to each other on the printed circuit board 34, for example light sources 40 with different colors, each of which is assigned to one of the display elements 38.

The light guide 44 shown in FIG. 2 has a coupling-in surface 46 for coupling in light from the receiving space 30 which has been emitted by the light source 40.

To this end, the light source 40 is arranged such that light emitted by the light source 40 during operation thereof is coupled through the coupling-in surface 46 into the section of the housing part 14 which is designed as a light guide 44.

The light guide 44 also has a first coupling-out surface 48 for coupling out light, which is arranged parallel to the connection side wall 18, and a second coupling-out surface 50 for coupling out light, which in the example embodiment shown is arranged on the second longitudinal side wall 24. However, the second coupling-out surface 50 may also be arranged on the first longitudinal side wall 22, the first end side wall 26, or the second end side wall 28.

The second coupling-out surface 50 shown in FIG. 2 is formed by a side face of the light guide 44 on the second longitudinal side wall 24 of the housing part 14.

The first coupling-out surface 48 is arranged such that, during operation, at least part of the light coupled in is coupled out perpendicular to the connection side wall 18.

The second coupling-out surface 50 is arranged such that, during operation, at least part of the light coupled in is coupled out perpendicular to the second longitudinal side wall 24.

The first coupling-out surface 48 and the second coupling-out surface 50 are furthermore arranged such that they merge into each other, i.e., around the edge connecting the second longitudinal side wall 24 to the connection side wall 18. In this respect, a common coupling-out surface 52 is formed, which extends continuously from the connection side wall 18 to the second longitudinal side wall 24 on an outer side of the housing part 14. This achieves particularly good perceptibility of the emitted light from different directions. In particular, the common coupling-out surface 52 can be viewed around the housing part 14 over an angle 54 of up to 270°, as indicated in FIG. 1.

The section of the housing part 14 which is shown in FIG. 2 and is designed as a light guide 44, comprises an extension 56 which protrudes into the receiving space 30 and is provided on the second longitudinal side wall 24, in particular has been manufactured in one piece during the manufacture of the second longitudinal side wall 24, i.e. in a common manufacturing step.

In the example embodiment, the extension 56 is designed as a rib 58 and extends along the second longitudinal side wall 24 up to the connecting side wall 18.

Shielding elements 60 are provided on the housing base 16 to prevent or at least reduce unintentional coupling out of light from the extension 56 into the receiving space 30.

More precisely, the one-piece housing base 16 has sections which are configured as shielding elements 60 and protrude into the receiving space 30. For example, as shown in FIG. 2, the shielding elements 60 are designed as ribs 58.

The housing part 14 and the housing base 16 are assembled such that the extension 56 designed as a rib 58 and the shielding elements 60 designed as ribs 58 engage with each other.

In other words, the extension 56 and the shielding elements 60 thus form engagement geometries 62 which cooperate and thus prevent or at least reduce unintentional coupling out of light from the light guide 44 into the receiving space 30.

The extension 56 designed as a rib 58 and the shielding elements 60 designed as ribs 58 can be in direct contact with each other so that, during operation, light coupled into the light guide 44 is reflected at the interface where the shielding elements 60 rest against the extension 56 and cannot enter the receiving chamber 30.

Alternatively, the extension 56 formed as rib 58 and the shielding elements 60 formed as ribs 58 can also be arranged at a distance from each other, in particular so that the gap width between the engaging parts is less than 10 mm, preferably less than 3 mm. This simplifies the assembly of the housing part 14 with the housing base 16.

If, as shown in FIG. 1, a plurality of display elements 38 close to each other is provided, by means of which light of different colors can be emitted, then it is possible to prevent or at least reduce the transfer of light of a certain color from the light guide 44 of one of the display elements 38 to the light guide 44 of another display element 38 by means of the shielding elements 60.

For example, the shielding elements 60 designed as ribs 58 can be arranged between the extensions 56 of the different light guides 44, which are also designed as ribs 58, to shield the extensions 56 from each other and thus prevent or at least reduce light transfer between the respective light guides 44.

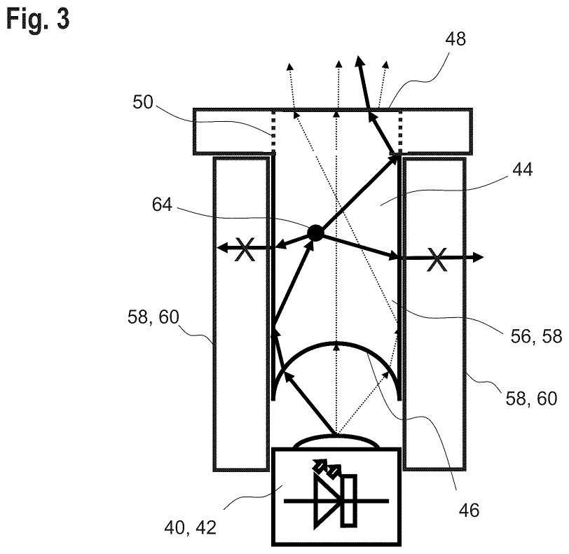

FIG. 3 shows a schematic sectional view of the extension 56 of the light guide 44 from FIG. 2 as viewed from the first longitudinal side wall 22.

The coupling-in surface 46 of the light guide 44 is, for example, lens-shaped and arranged directly above the light source 40. This allows light emitted by the light source 40 to be coupled into the light guide 44 in a particularly uniform manner.

As already explained, the one-piece housing part 14 and thus also the connecting side wall 18, the first longitudinal side wall 22, the second longitudinal side wall 24, the first end side wall 26, and the second end side wall 28 thereof are made of partially transparent material, in particular plastic.

A special feature of the described embodiment is that the housing part material comprises homogeneously distributed optical scatterers 64, for example color pigments, gas bubbles, or inorganic particles.

It is therefore conceivable that the optical scatterers 64 are color pigments which are designed to scatter light coupled into the light guide 44 during operation and at the same time color the housing part 14 in a predetermined color.

The optical scatterers 64 may be organic pigments, for example azo pigments, which color the housing part 14 yellow, orange, or red, phthalocyanine pigments, which color the housing part 14 blue or green, quinacridone pigments, which color the housing part 14 bright red, or dioxazine pigments, which color the housing part 14 violet.

Alternatively, it is also possible to use inorganic pigments, for example titanium dioxide pigments, which color the housing part 14 white, iron oxide pigments, which color the housing part 14 red, yellow, and brown, chrome oxide green pigments, which color the housing part 14 green, ultramarine blue pigments, which color the housing part 14 bright blue, or carbon black particles, which color the housing part 14 black or gray.

Pearlescent pigments or metal pigments can also be used to give the housing part 14 a metallic appearance and/or to create iridescent effects.

Alternatively or additionally, fluorescent pigments can also be mixed into the at least partially transparent material to improve the visibility of the housing part 14 in low-light environments.

Of course, in addition to pigments, other dyes can also be used to color the housing part 14, for example, disperse dyes or solvent-based dyes.

The optical properties of the housing part 14, in particular the sections designed as light guides 44, depend significantly on the size and geometry of the optical scatterers 64.

Spherical particles such as carbon black or titanium dioxide can be used as optical scatterers 64. These exhibit good dispersibility in the at least partially transparent material and increase the opacity thereof.

Plate-shaped particles, such as mica or pearlescent pigments, can also be used to improve the barrier properties of the housing part 14 and thus the protection of the internal electronic components 32 against external influences.

Needle-shaped or fibrous particles, such as wollastonite, can also be used as optical scatterers 64 to increase the mechanical strength and stiffness of the housing part 14 in addition to the optical effects.

Furthermore, ceramic particles can also be added to the at least partially transparent material as optical scatterers 64, which increase the thermal conductivity of the housing part 14 and thus improve the removal of waste heat generated by the electronic components 32.

It is also conceivable to use hollow spheres as optical scatterers 64, in particular made of glass, to reduce the weight of the housing part 14 and/or improve the electrical insulation properties thereof.

Alternatively or additionally, gas bubbles finely distributed in the at least partially transparent material can also be used as optical scatterers 64. These can be produced by adding foaming chemicals and/or gases to the at least partially transparent material, in particular the flowable plastic mass, during manufacture of the housing part 14.

An advantage of the gas bubbles as optical scatterers 64 is that, compared to other types of optical scatterers 64, e.g., color pigments, less light is absorbed by the optical scatterers 64 themselves, so that fewer parasitic absorption losses occur in the light guide 44. This improves the light output.

The optical scatterers 64 have a size of less than 50 μm, preferably 0.1 μm to 10 μm, for example. It has been shown that optical scatterers 64 in this size range scatter light guided in the light guide 44 very efficiently and can be easily mixed with the at least partially transparent material during manufacture.

As shown schematically in FIG. 3, optical scatterers 64 are also arranged between the coupling-in surface 46 and the first coupling-out surface 48. They scatter the light coupled in via the coupling-in surface 46 such that a scattered portion of the light strikes the second coupling-out surface 50 (which is located in the drawing plane in FIG. 3).

As already explained with reference to FIG. 2, the shielding elements 60 are located, for example, on the side of the extension 56 of the light guide 44 and prevent unwanted coupling-out of light into the receiving space 30. This is symbolized in FIG. 3 by the crossed-out arrows.

In the example embodiment, a concentration of the optical scatterers 64 in the at least partially transparent material is so high that at least 15%, 25%, preferably 50% or even more than 75% of the light coupled into the light guide 44 during operation is scattered in the light guide 44 by the optical scatterers 64 such that it is coupled out through the side face of the light guide 44, which forms the second coupling-out surface 50. In other words, a sufficiently high proportion of the light coupled into the light guide 44 is deflected by scattering at the optical scatterers 64 so that it strikes the second coupling-out surface 50 and can be coupled out there, even though the second coupling-out surface 50 is arranged substantially perpendicular to the coupling-in surface 46 in the embodiment.

Alternatively or additionally, it may also be provided that the concentration of the optical scatterers 64 in the at least partially transparent material is so high that, due to scattering, so much light is coupled out laterally from the light guide 44 (into the drawing plane in FIG. 3) that at least approximately equal luminance values are achieved for the first and the second coupling-out surface 48, 50.

In this way, uniform light coupling out of the respective coupling-out surfaces 48, 50 can be achieved. The two luminous surfaces thus appear equally bright to an observer.

The one-piece housing part 14 itself, or rather the sections thereof which are designed as light guides 44, guide and distribute light coupled in to the various sides of the housing, where it can be coupled out through the respective coupling-out surfaces 48, 50. This creates indicator lights 36 that are clearly visible from different viewing directions and at the same time effectively protect the electronics located in the housing.

List of reference numerals

| Reference | |
|---|---|
| numeral | Designation |
| 10 | electronic device |
| 12 | housing assembly |
| 14 | housing part |
| 16 | housing base |
| 18 | connection side wall |
| 20 | connection |
| 22 | first longitudinal side wall |
| 24 | second longitudinal side wall |
| 26 | first end side wall |
| 28 | second end side wall |
| 30 | receiving space |
| 32 | electronic component |
| 34 | printed circuit board |
| 36 | indicator light |
| 38 | display element |
| 40 | light source |
| 42 | light-emitting diode |
| 44 | light guide |
| 46 | coupling-in surface |
| 48 | first coupling-out surface |
| 50 | second coupling-out surface |
| 52 | common coupling-out surface |
| 54 | angle |
| 56 | extension |
| 58 | rib |
| 60 | shielding element |
| 62 | engagement geometry |
| 64 | optical scatterer |

1. A housing assembly for an electronic device, comprising at least one partially transparent housing part which is formed in one piece, having a connection side wall, a first longitudinal side wall, a second longitudinal side wall, a first end side wall, and a second end side wall, wherein the side walls together delimit a receiving space for at least one electronic component of the electronic device, wherein at least a section of the housing part is designed as a light guide which has a coupling-in surface for coupling in light from the receiving space, a first coupling-out surface for coupling out light, which is arranged on the connection side wall such that at least part of the light coupled in is coupled out perpendicular to the connection side wall, and which has a second coupling-out surface for coupling out light, which is arranged on one of the longitudinal side walls or end side walls such that at least part of the light coupled in is coupled out perpendicular to the respective longitudinal side wall or end side wall.

2. The housing assembly according to claim 1, comprising an extension which is provided on one of the longitudinal side walls or end side walls and projects into the receiving space and comprises the coupling-in surface.

3. The housing assembly according to claim 2, wherein the extension projecting into the receiving space is configured as a rib extending along the respective longitudinal side wall or end side wall in a direction of the connecting side wall.

4. The housing assembly according to claim 1, wherein the first coupling-out surface and the second coupling-out surface merge into each other to form a common coupling-out surface which extends continuously on an outer side of the housing part from the respective longitudinal side wall or end side wall to the connection side wall.

5. The housing assembly according claim 1, wherein the housing part comprises an engagement geometry into which a shielding element can engage so as to shield and/or reflect light coupling out of the light guide into the receiving space during operation.

6. The housing assembly according to claim 1, wherein the connection side wall, the first longitudinal side wall, the second longitudinal side wall, the first end side wall, and the second end side wall are formed from an at least partially transparent material which comprises homogeneously distributed optical scatterers.

7. The housing assembly according to claim 6, wherein the optical scatterers are arranged between the coupling-in surface and the first coupling-out surface, and wherein the optical scatterers scatter light coupled in via the coupling-in surface such that a scattered portion of the light strikes the second coupling-out surface.

8. The housing assembly according to claim 6, wherein at least part of the second coupling-out surface is formed by a side face of the light guide and wherein a concentration of the optical scatterers in the at least partially transparent material is so high that at least 15% of the light coupled into the light guide during operation is scattered in the light guide by the optical scatterers so as to be coupled out through the side face of the light guide.

9. The housing assembly according to claim 6, wherein at least part of the second coupling-out surface is formed by a side face of the light guide and wherein a concentration of the optical scatterers in the at least partially transparent material is so high that more than 75% of the light coupled into the light guide during operation is scattered in the light guide by the optical scatterers so as to be coupled out through the side face of the light guide.

10. The housing assembly according to claim 6, wherein at least part of the second coupling-out surface is formed by a side face of the light guide and wherein a concentration of the optical scatterers in the at least partially transparent material is so high that, due to scattering, so much light is coupled out laterally from the light guide that at least approximately equal luminance values are achieved for the first coupling-out surface and the second coupling-out surface.

11. The housing assembly according to claim 6, wherein the optical scatterers are color pigments which are designed to scatter light coupled into the light guide during operation and which simultaneously color the housing part in a predetermined color.

12. An electronic device, comprising a housing assembly according to claim 1, a printed circuit board received in the receiving space of the housing part having at least one light source arranged such that light emitted by the light source during operation thereof is coupled through the coupling-in surface into the section of the housing part configured as a light guide, and a housing base which closes the receiving space.

13. The electronic device according to claim 12, wherein at least a section of the housing base is configured as a shielding element which protrudes into the receiving space and engages with an engagement geometry of the housing part so as to shield and/or reflect light coupling out of the light guide into the receiving space during operation.
